(19) United States
(12) Patent Application Publication
(10) Pub. No.: US 2012/0252485 A1
(43) Pub. Date: Oct. 4, 2012

(54) System and Method for Determining Best Available Location for a Mobile Device

(76) Inventors: Andrew N. Wolverton, Plano, TX (US); Wayne Stargardt, Dallas, TX (US); Jeffrey O. Smith, Dallas, TX (US)

(21) Appl. No.: 13/435,276

(22) Filed: Mar. 30, 2012

Related U.S. Application Data
(60) Provisional application No. 61/470,594, filed on Apr. 1, 2011.

(51) Int. Cl. H04W 24/00; H04W 52/02

(52) U.S. Cl. 455/456.1

(57) ABSTRACT

A system and method for determining a location of a mobile device is described that attempts to determine the location of the mobile device using a variety of location determination technologies according to a hierarchy of location determination technologies, where the most accurate technologies are attempted before less accurate technologies until a location determination is made for the mobile device. The hierarchy of location determination technologies includes each of: autonomous GPS, assisted GPS, primary carrier network location based services, tri-lateration, secondary carrier network location based services, and serving base station location.

### CROSS REFERENCE TO RELATED INFORMATION

This application claims the benefit of U.S. Patent Application Ser. No. 61/470,594, filed Apr. 1, 2011.

### TECHNICAL FIELD

The present disclosure is directed to obtaining terrestrial location data for mobile devices, and more particularly to using a hierarchy of location determination technologies to obtain the best possible location data for a mobile device based on access to particular technologies.

### BACKGROUND OF THE INVENTION

Geo-location is determination of the real world location of an object. In many applications, particularly with smart phones and car navigation systems, geo-location services have become ubiquitous. The most sophisticated methods presently available for locating mobile, cellular-enabled devices are used in consumer smart phone applications. These approaches use a sequential process of trying the best available technique, usually global positioning satellite (GPS) first, then a less accurate technique, such as cellular network location services, if the first is unavailable or not sufficient, and so on. These smart phone applications do not use certain techniques, such as tri-lateration as one of their options, however, and they also only use the carrier Location Based Services (LBS) services for the device's home carrier and do not use facilities on other carriers when roaming onto those carriers.

In general, this sequential method to locating cellular devices does not use all of the available options for location determination, is not available to commercial applications, and has not been previously provided to Machine-to-Machine (M2M) devices that are not operated by a human subscriber.

### BRIEF SUMMARY OF THE INVENTION

In a preferred embodiment, a method for determining a location of a mobile device is described. The method activates location determination programming at the mobile device to determine the physical location of the mobile device and attempts to determine the location of the mobile device using a variety of location determination technologies according to a hierarchy of location determination technologies, where the most accurate technologies are attempted before less accurate technologies until a location determination is made for the mobile device. The hierarchy of location determination technologies includes each of: autonomous GPS, assisted GPS, carrier network location based services, tri-lateration and serving base station location.

In another preferred embodiment, a system for determining the location of a mobile device is described. The system includes at least one mobile device, where the location of the mobile device is unknown, and a data center for tracking the location of the mobile device. The location of the mobile device is determined using a variety of location determination technologies according to a hierarchy of location determination technologies, where the most accurate technologies are attempted before less accurate technologies until a location determination is made for the mobile device. The hierarchy of location determination technologies includes each of: GPS, assisted GPS, carrier network location based services, tri-lateration and serving base station location.

In yet another preferred embodiment, a method for determining a location of a mobile device is described. The method includes determining whether assisted GPS services are available, and where available attempting a GPS based location fix using assisted GPS. The method further includes attempting a GPS based location fix for the mobile device using autonomous GPS where assisted GPS is not available, and determining whether the GPS based location fix is sufficiently accurate. Where the GPS based location fix is not sufficiently accurate, the method attempts a location fix based on cellular network location based services, and determines whether the cellular network location based services location fix is sufficiently accurate. Where the cellular network location based services location fix is not sufficiently accurate, the method attempts a location fix based on tri-lateriation of cellular base stations, and determines whether the tri-lateriation location fix is sufficiently accurate. Finally, where the tri-lateriation location fix is not sufficiently accurate, the method attempt determines a location for a serving base station for the mobile device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of an embodiment of a system for determining the most accurate location data for a mobile device given its current conditions according to the concepts described herein;

FIG. 2 is a graph showing the relative accuracy of location determination technologies in view of success rate;

FIG. 3 is a flow chart of an embodiment of a method for determining the most accurate location data for a mobile device given its current conditions according to the concepts described herein; and

FIG. 4 is a block diagram of an embodiment of an asset tag having location determining capabilities for a mobile object according to the concepts described herein.

### DETAILED DESCRIPTION OF THE INVENTION

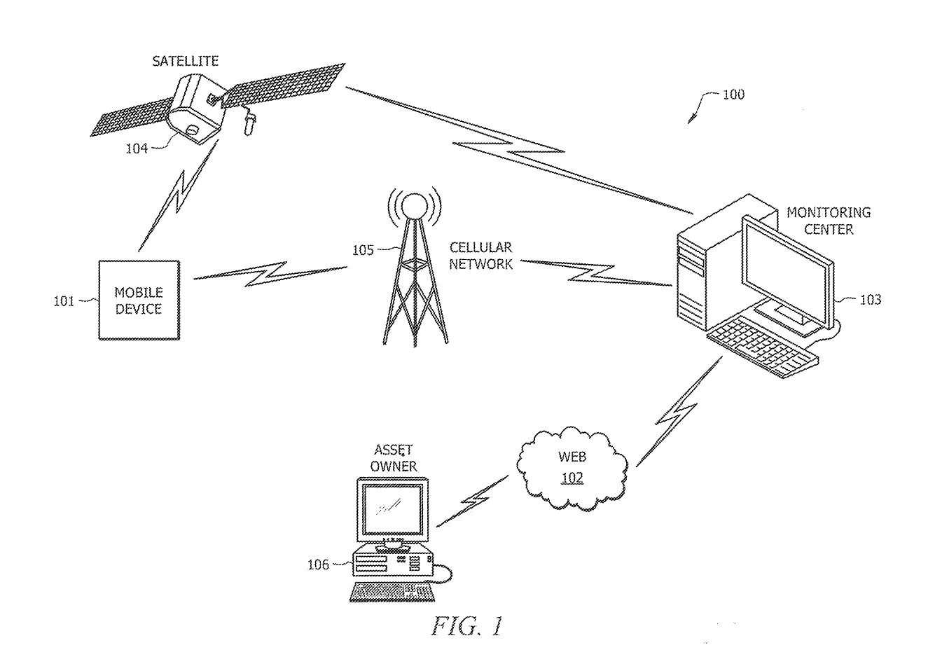

Referring now to FIG. 1, a preferred embodiment of a system 100 for making a best case location determination for a mobile object is shown. The mobile object 101 includes at least a satellite receiver and cellular transceiver for making location determination capabilities using satellite technologies such as GPS, cellular based location technologies, or other location determination technologies as are available and practical. The location determination capabilities may be built into the mobile object or part of an asset tracking tag associated with the mobile object. In certain embodiments, the mobile object or its associated asset tag would be able to receive GPS signals from satellite network 104 where they are available and send its location coordinates to a data center 103 using the cellular network 105, satellite communications, or other communications protocol. If the GPS signal is not available, the mobile unit could then descend a hierarchy of location determination technologies, including cellular location determination techniques using cellular network 105, until it is able to make a best case location determination. Historical data can also be used to improve the accuracy of the location data.

After mobile device 101 has made a location determination based on a particular type of service, data center, or monitoring center, 103 receives the location information from the mobile device 101 and determines whether the location information from the mobile device is sufficiently accurate. If the location information is not sufficiently accurate, the data center 103 instructs mobile device 101 to proceed to the next most accurate location determination service. The owner of the mobile device, asset owner 106, can retrieve location and other data from data center 103 using an Internet 102 connection.

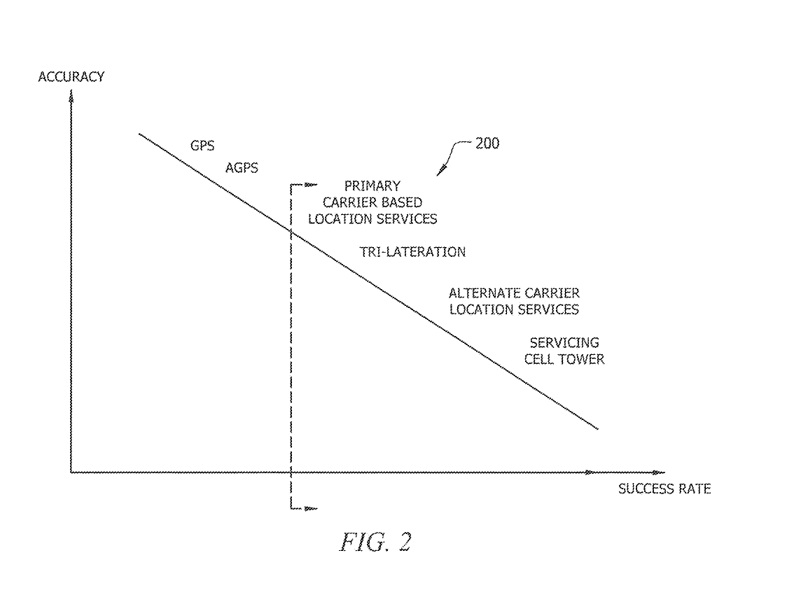

Referring now to FIG. 2, graph 200 shows a plotting of different location determination technologies against accuracy on the vertical scale and success rate on the horizontal scale. As can be seen, the most accurate technologies tend also to have the lowest success rate based on signal availability and strength. The most accurate technologies are satellite based and do not work well inside enclosed spaces and are subject to a variety of other factors. The least accurate technology merely reports the location of the cell tower to which a device is currently communicating. In between are assisted GPS, carrier assisted location services, and tri-lateration using nearby cell towers. The dashed line on the graph shows autonomous services on the right and external network assisted services on the left.

“Standalone” or “Autonomous” GPS operation uses radio signals from satellites alone. Assisted GPS, (AGPS or A-GPS) additionally uses network resources to locate and utilize the satellites in poor signal conditions. In very poor signal conditions, for example in a city, these signals may suffer multipath propagation where signals bounce off buildings, or be weakened by passing through atmospheric conditions, walls or tree cover. When first turned on in these conditions, some standalone GPS navigation devices may not be able to work out a position due to the fragmentary signal, rendering them unable to function until a clear signal can be received continuously.

An Assisted GPS system can address these problems by using data available from a network. Assistance falls into two categories. First, information used to more quickly acquire satellites. The network can provide to the GPS receiver precise time or orbital data or almanac data for the GPS satellites enabling the GPS receiver to lock to the satellites more rapidly in some cases. Second, the remote server can calculate position using information from the GPS receiver. The device captures a snapshot of the GPS signal, with approximate time, for the server to later process into a position. The assistance server has a good satellite signal, and plentiful computation power, so it can compare fragmentary signals relayed to it.

A typical A-GPS-enabled receiver will use a data connection (Internet or other) to contact the assistance server for GPS information. If it also has functioning autonomous GPS, it may use standalone GPS, which is sometimes slower on time to first fix, but does not depend on the network.

With carrier based location services, the cellular network carriers use signal strength information in their cellular networks to determine the location of a mobile device using their network. The present invention can use a primary carrier's network for location based services or can use an alternate carrier if the primary carrier is unavailable.

Tri-lateration uses cell tower signal strength to calculate the approximate position of the mobile device. Tri-lateration determines the sector in which the mobile phone resides and roughly estimates also the distance to the base station. Further approximation is done by interpolating signals between at least two other adjacent antenna towers. Tri-lateration services may achieve a precision of down to 50 meters in urban areas where mobile traffic and density of antenna towers (base stations) is sufficiently high. Rural and desolate areas may see miles between base stations and therefore determine locations less precisely.

Using the serving cell tower for location merely plots the location of the cell tower being used by the mobile device and uses that as the mobile devices current location.

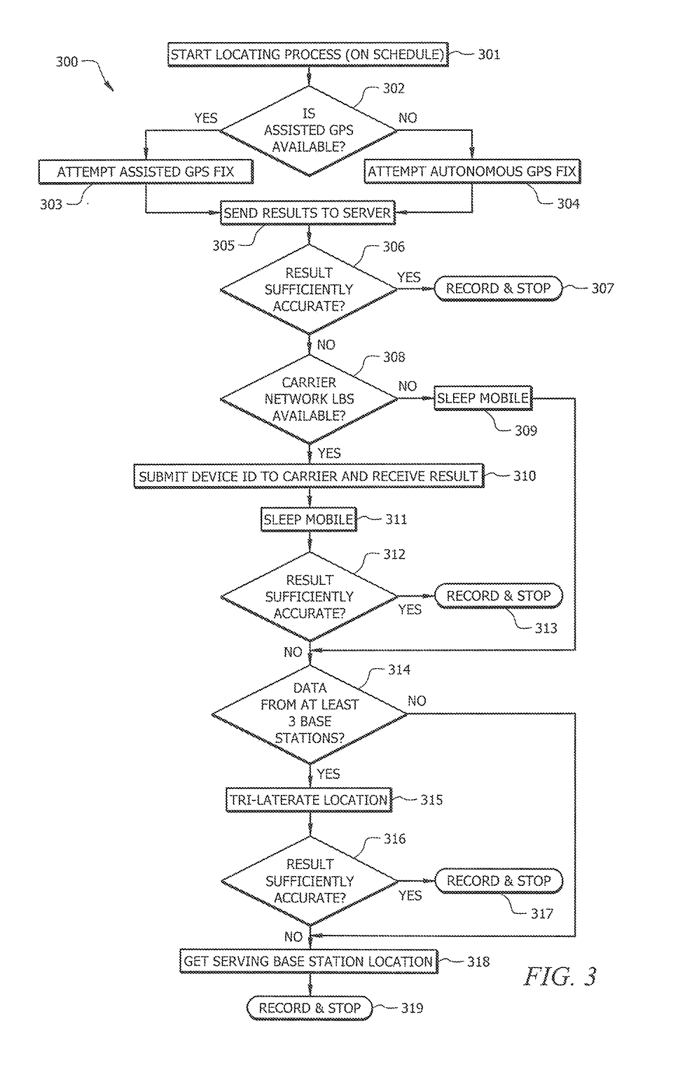

Referring now to FIG. 3, an embodiment of a method for determining the best available location information for a mobile, battery-operated, cellular-based device is described. The method 300 attempts different locating technologies in sequence, from generally most accurate to least accurate, in sequence until a device location is determined with sufficient accuracy or all available locating technologies are exhausted. In preferred embodiments, the location technologies, in order of general accuracy, are: 1) autonomous GPS, 2) assisted GPS (whether determined in the network plane or user plane), 3) primary carrier network-based location service, 4) tri-lateration from serving cell site and neighboring cell sites, 5) other carrier network-based location services (including generic approximation from serving cell site location with timing advance information), and 6) serving cell site location, though other technologies can be incorporated into the method.

The sequence based on accuracy also is generally indicative of power consumption, from most power consuming technology to least. Consequently, the method powers down the mobile device radio as quickly as possible in the sequence to maximize the battery operating life of the device. The selection to use autonomous or assisted GPS can also be made to sacrifice some location accuracy to minimize power consumption.

The accuracy and time required to use the above-described methods for determining location can, in some embodiments, be enhanced by using historical data stored in the device or network. The historical data can be used to provide previous locations that can be used to improve the accuracy of the location determination.

Method 300 begins in block 301 where the mobile device starts the location determination process. The mobile device can be activated from a sleep mode either on a predetermined schedule, upon the occurrence of an event, detection of an environmental condition, or other criteria as may be appropriate. Once the device is active, it determines if assisted GPS services are available by looking for the GPS signals and determining the sufficiency of their signal strength, as shown by decision block 302. If assisted GPS is available, an assisted GPS fix is attempted as shown by block 303. If assisted GPS is not available, block 304 shows attempting to use autonomous GPS to get a location fix. While autonomous GPS is potentially more accurate, the assisted GPS fix can occur more quickly and therefore use less battery power than the autonomous GPS fix. While method 300 shows choosing the assisted GPS fix if available, the method could easily try the autonomous GPS fix first before trying the assisted GPS fix, if the additional accuracy is desirable for the application. Additionally, the calculation of the GPS location can occur either at the device or can occur at the remote server at the data monitoring center depending on the nature of the mobile device and application.

The results of the assisted GPS fix or autonomous GPS fix are sent to the server, block 305, using whatever connectivity is available to the mobile device, such as cellular or wireless networking. Block 306 determines whether the results of the GPS fix are sufficiently accurate for the application. If it is sufficiently accurate, the location is recorded and the method stops, as shown by block 307. The device can then perform other functions or return to its sleep mode. If the result is determined not to be sufficiently accurate, method 300 passes to block 308 where it is determined if the primary carrier network location based services are available. If they are not available, block 309 shows the mobile device being put back into sleep mode before the process passes to block 314, which will be discussed below.

If the carrier network location based services are available the device ID is submitted to the carrier, as shown by block 310. Once the result is received, the device is placed into its sleep mode. The device is able to be put into sleep mode, block 311, after the checking for the primary carrier's location based services because the remaining location based services rely on the last cell signal or other information that has been sent by the mobile device or can be retrieved from the cellular carrier. As the services do not rely on the participation of the mobile device itself, but instead occur at the data center or other server remote to the mobile device, the mobile device can be put into sleep mode to conserve battery power.

Block 312 determines whether the result of the carrier network location based services are sufficiently accurate. If they are, the method passes to block 313 where the results are recorded and the method stops. If not, the method passes to block 314 where the method determines whether data from at least 3 cellular base stations is available to allow the system to use tri-lateration to determine the position of the mobile device. If not, the method passes to block 318 where the location of the serving base station is retrieved. If there is sufficient data from three base stations, the remote server at the data center or other location uses the data to tri-laterate the location according to known techniques, as shown by block 315. Block 316 determines if the results of the tri-lateration are sufficiently accurate. If they are, the results are recorded and the method stops as shown by block 317. If not, the method passes to block 318 which retrieves the location of the serving base station. The method then passes to block 319 where the location of the serving base station is recorded and the method stops.

While a particular embodiment showing a particular sequence is described in FIG. 3, other location determination mechanisms can be inserted into the method according to their accuracy and likelihood of success without departing from the scope of the concepts described herein. For example, if tri-lateration is unsuccessful, the method attempts to use the location based services of an alternative carrier to the primary carrier to get a location before retrieving the serving base station location. Also, the order of the method can be adjusted to account for changing accuracies of the location determination mechanisms or to use the least battery consuming mechanisms that meet the required accuracy first.

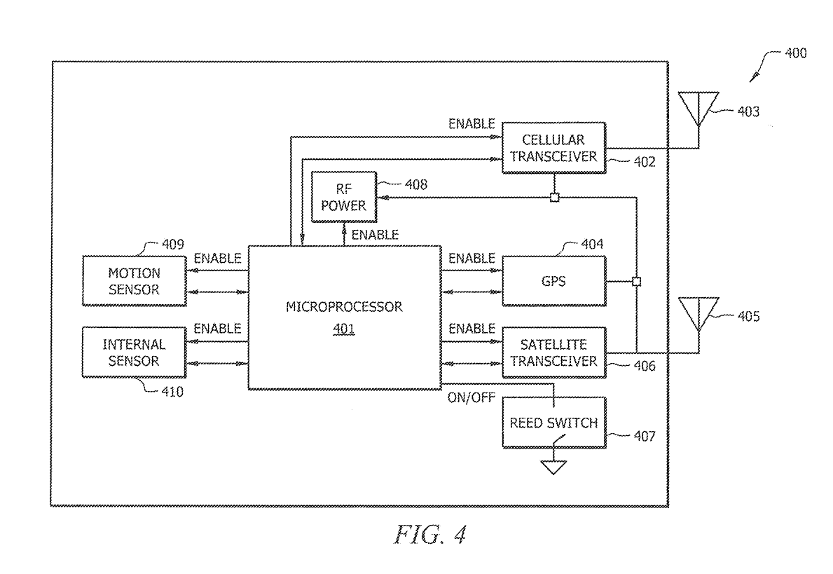

Referring now to FIG. 4, an embodiment of an exemplary mobile device or mobile device asset tag 400 is described. The tag 400 includes a microprocessor 401 programmable to execute desired instructions and to control the operation of tag 400. The processor 401 may have internal memory capable of storing data and programming information or may use memory external to the microprocessor. The tag 400 also includes a cellular transceiver 402 and associated cellular antenna 403 to perform cellular communications. Power for the cellular transceiver is supplied by RF power module 408. The tag 400 also includes a satellite location determination device 404, which can be GPS or satellite service based, and a satellite transmitter, receiver or transceiver 406, which uses satellite antenna 405.

As described, communications with the data center can be done using satellite, cellular or other long range communication systems. Sensors 409, 410 can be embedded in or connected to the device to detect motion or other environmental information. Such information can be collected and reported to the data center or can also be used to trigger actions by the mobile device. Reed switch is an electrical switch that is activated by a magnetic field and can be used to enable or disable the device.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for determining a location of a mobile device comprising:
activating location determination programming at the mobile device to determine the physical location of the mobile device;
attempting to determine the location of the mobile device using a variety of location determination technologies according to a hierarchy of location determination technologies, where the most accurate technologies are attempted before less accurate technologies until a location determination is made for the mobile device;
wherein the hierarchy of location determination technologies includes each of: autonomous GPS, assisted GPS, carrier network location based services, tri-lateration and serving base station location.

2. The method of claim 1 wherein the carrier network location based services is a primary carrier network location based services and the hierarchy of location determination technologies also includes a secondary carrier network location based services.

3. The method of claim 1 wherein the order of the hierarchy of location determination technologies is, from most desirable to least desirable, autonomous GPS, assisted GPS, carrier network location based services, tri-lateration and serving base station location.

4. The method of claim 1 wherein the mobile device is a mobile asset tag.

5. The method of claim 4 wherein the mobile asset tag includes a processor, a cellular transceiver, an a satellite transceiver.

6. The method of claim 1 wherein the assisted GPS location determination is preferred over the autonomous GPS to conserve battery power at the mobile device.

7. The method of claim 1 wherein the mobile device is put in sleep mode after attempting location fixes based autonomous GPS, assisted GPS, carrier network location based services.

8. The method of claim 1 further comprising recording the location of the mobile device at a data center.

9. A system for determining the location of a mobile device comprising:
at least one mobile device, wherein the location of the mobile device is unknown; and
a data center for tracking the location of the mobile device;
wherein the location of the mobile device is determined using a variety of location determination technologies according to a hierarchy of location determination technologies, where the most accurate technologies are attempted before less accurate technologies until a location determination is made for the mobile device, wherein the hierarchy of location determination technologies includes each of: GPS, assisted GPS, carrier network location based services, tri-lateration and serving base station location.

10. The method of claim 9 wherein the carrier network location based services is a primary carrier network location based services and the hierarchy of location determination technologies also includes a secondary carrier network location based services.

11. The method of claim 9 wherein the order of the hierarchy of location determination technologies is, from most desirable to least desirable, autonomous GPS, assisted GPS, carrier network location based services, tri-lateration and serving base station location.

12. The method of claim 9 wherein the mobile device is a mobile asset tag.

13. The method of claim 12 wherein the mobile asset tag includes a processor, a cellular transceiver, an a satellite transceiver.

14. The method of claim 9 wherein the assisted GPS location determination is preferred over the autonomous GPS to conserve battery power at the mobile device.

15. The method of claim 9 wherein the mobile device is put in sleep mode after attempting location fixes based autonomous GPS, assisted GPS, carrier network location based services.

16. A method for determining a location of a mobile device comprising:
determining whether assisted GPS services are available, and where available attempting a GPS based location fix using assisted GPS;
attempting a GPS based location fix for the mobile device using autonomous GPS where assisted GPS is not available;
determining whether the GPS based location fix is sufficiently accurate;
where the GPS based location fix is not sufficiently accurate, attempting a location fix based on cellular network location based services;
determining whether the cellular network location based services location fix is sufficiently accurate;
where the cellular network location based services location fix is not sufficiently accurate, attempting a location fix based on tri-lateriation of cellular base stations;
determining whether the tri-lateriation location fix is sufficiently accurate; and
where the tri-lateriation location fix is not sufficiently accurate, determining a location for a serving base station for the mobile device.

17. The method of claim 16 wherein the carrier network location based services is a primary carrier network location based services and the method further comprises attempting a location fix based a secondary carrier network location based services.

18. The method of claim 16 wherein the mobile device is a mobile asset tag.

19. The method of claim 18 wherein the mobile asset tag includes a processor, a cellular transceiver, an a satellite transceiver.

20. The method of claim 16 further comprising after determining whether the cellular network location based services location fix is sufficiently accurate, sleeping the mobile device to conserve battery power.
